(19) United States
(12) Patent Application Publication
(10) Pub. No.: US 2006/0034072 A1
(43) Pub. Date: Feb. 16, 2006

(54) Waterproof flashlight

(76) Inventor: Tsung-Yuan Shih, Tainan City (TW)

Correspondence Address: Tsung-Yuan Shih, P.O. Box 90, Tainan City, 704, TW

(21) Appl. No.: 10/916,388

(22) Filed: Aug. 12, 2004

(51) Int. Cl. F21L 4/00

(52) U.S. Cl. 362/157

(57) ABSTRACT

A waterproof flashlight includes a cylindrical housing 1, a rotatable annular switch 10, a cylindrical cap 2, an anti-leak gasket 3, a light reflecting member 12, a lens 4, plural light emitting diodes 13 and a position ring 5. The anti-leak gasket, the lens and the position ring are positioned in the cylindrical cap, and the rotatable annular switch is threadably combined with a lower end section of the cylindrical housing. When the rotatable switch is rotated tightly relative to the cylindrical housing, the diodes are turned on to emit light beam, reflected by the light-reflecting member to shoot through the lens. The anti-leak gasket can prevent water from flowing or seeping in the interior of the flashlight.

### BACKGROUND OF THE INVENTION

1. Field of the Invention

This invention relates to a waterproof flashlight, particularly to one capable to prevent water from flowing or seeping into its interior by provision of a leak-preventing gasket provided in a cylindrical cap threadably closing up an upper end of a cylindrical housing, which has its lower end threadably combined with a rotatable annular switch. Further, a lens and a position ring are also provided in the cap for letting through the beam of light emitted by plural light emitting diodes positioned in an upper concave surface of a light reflecting member fixed in an upper end of the cylindrical housing and under the lens.

2. Description of the Prior Art

Conventional flashlights generally have a lamp in an upper section of a cylindrical housing, a battery or plural batteries positioned in the cylindrical housing, and a switch for turning on and off the lamp, without any structure of waterproofing. So they easily become wet in case of raining, giving rise to malfunction of the electric circuit and the battery by causing short circuit.

### SUMMARY OF THE INVENTION

This invention has bee devised to offer a waterproof flashlight with a simple structure to handle very easily.

The feature of the invention is a rotatable annular switch and an anti-leak gasket, and the switch is threadably combined with a lower end of a cylindrical housing for turning on and off the power of a battery or plural batteries contained in the cylindrical housing so as to control plural light emitting diodes provided in a light reflecting member of a concave shape fixed in an upper section of the cylindrical housing. The anti-leak gasket is fitted in the annular groove of a cylindrical cap threadably combined with an upper section of the cylindrical housing, and a lens and a position ring are contained in the interior cavity of the cap for the beams of the diodes to pass through. Thus the flashlight in the invention can prevent water from flowing or seeping in its interior through the connecting lines of the cap with the housing.

### BRIEF DESCRIPTION OF DRAWINGS

This invention will be better understood by referring to the accompanying drawings, wherein:

FIG. 1 is an exploded perspective view of a waterproof flashlight in the present invention;

FIG. 2 is a cross-sectional view of the waterproof flashlight in the present invention; and,

FIG. 3 is a perspective view of the waterproof flashlight in the present invention.

### DETAILED DESCRIPTION OF THE PREFERRED EMBODIMENT

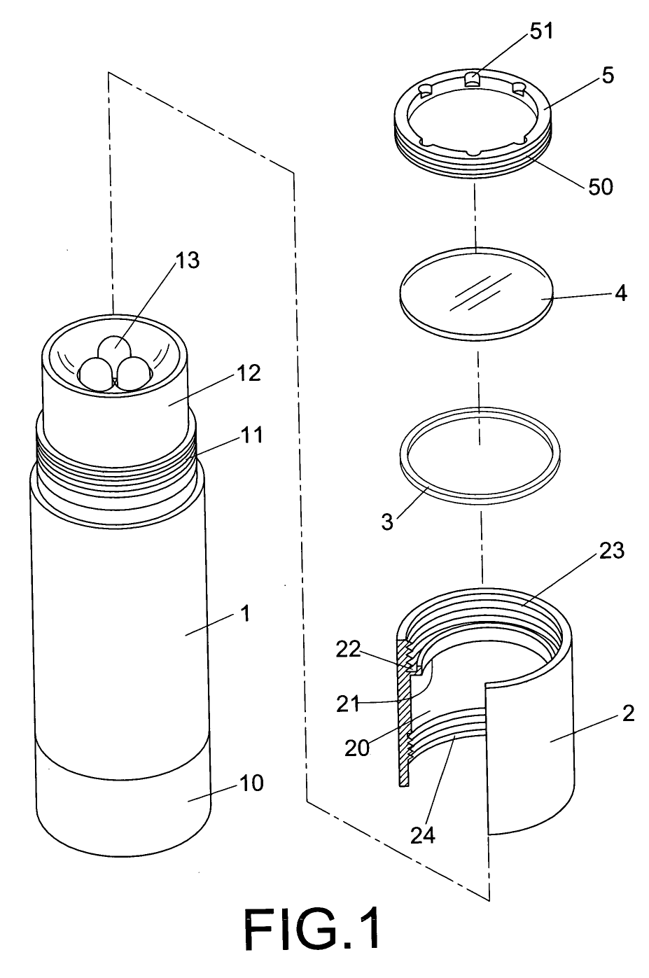

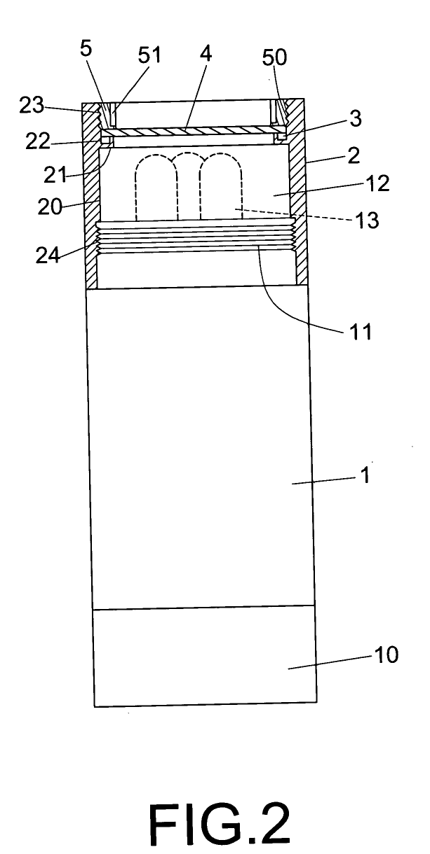

A preferred embodiment of a waterproof flashlight in the present invention, as shown in FIGS. 1 and 2, includes a cylindrical housing 1, a rotatable annular switch 10, a light reflecting member 12, a plurality of light emitting diodes 13, a cylindrical cap 2, an annular anti-leak gasket 3, a lens 4 and a position ring 5 as main components combined together.

The cylindrical housing 1 has a proper length, an hollow interior for containing batteries as power for lighting the light emitting diodes 13, and male threads 11 formed on an outer surface of the upper end section, the light reflecting member 12 of a concave shape is fixed in the upper end, and the plurality of light emitting diodes 13 are fitted in an upper concave surface of the light reflecting member.

The cylindrical cap 2 is threadably combined with the upper end of the cylindrical housing 1, having a hollow cavity 20, a stop annular edge 21 formed in an inner wall, an annular groove 22 formed also in the inner wall on the stop annular edge 21, and female threads 23 and 24 respectively formed in an upper portion and a lower portion of the inner surface of the hollow cavity.

The annular anti-leak gasket 3 is fitted closely around in the annular groove 22 of the cap 2.

The lens 4 is positioned in the hollow cavity 20 of the cap 2 just on the anti-leak gasket 3 above the diodes 13 for the light beam of the diodes 13 to pass through and to protect them.

The position ring 5 is combined in the hollow cavity 20, having male threads 50 on its outer surface and a plurality of engage grooves spaced apart in its inner surface.

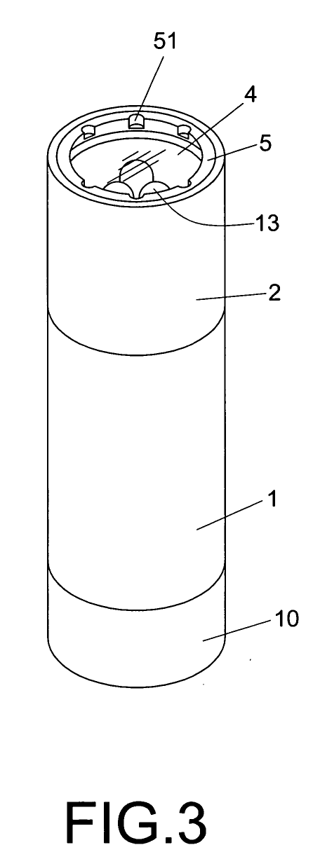

Next, in assembling, referring to FIGS. 1, 2 and 3, firstly the anti-leak gasket 3 is to be fitted in the annular groove 22 of the cap 2, with the lens 4 positioned on the annular stop edge 21 in the hollow cavity 20 of the cap 2. Next, the position ring 5 is threadably combined with the cap, engaging the male threads 50 of the position ring 5 with the female threads 23 of the cap 2. Then the position ring 5 is tightened to press the lens 4 and the anti-leak gasket 3 down, letting the lens 4 closely rest on the annular anti-leak gasket 3 and the stop edge 21. Then the cap 2 is threadably combined with the cylindrical housing 1, by engaging the female threads 24 of the cap 2 with the male threads 11 of the cylindrical housing 1, finishing assembly of the waterproof flashlight with easiness and quickness.

In case the lens 4 is damaged, it can be taken off and replaced by using a tool, which is inserted in the engage grooves 51 of the position ring 5, disengaging the position ring 5 from the cap 2 by rotating it reversely, quite convenient.

Next, in using, if the rotatable annular switch 10 is rotated tightly relative to the cylindrical housing 1, the light emitting diodes 13 are turned on to light up so that the light beam of the diodes 13 may be shot out reflected by the reflecting member 12 through the lens 4. And the anti-leak gasket 3 can hamper water from flowing or seeping in the hollow interior of the flashlight through the connecting lines of the cap 2 and the cylindrical housing, not causing short circuit by any means.

While the preferred embodiment of the invention has been described above, it will be recognized and understood that various modifications may be made therein and the appended claims are intended to cover all such modifications that may fall within the spirit and scope of the invention.

What is claimed is:

1. A waterproof flashlight comprising:
a cylindrical housing of a proper length for containing a battery or plural batteries, having male threads formed in an outer surface of its upper end section;
a rotatable annular switch threadably combined with a lower end section of said cylindrical housing for tuning on and off an electric circuit;
a light-reflecting member of a concave shape fixed tightly in an upper end of said cylindrical housing and extending upward;
a plurality of light emitting diodes fitted in a concave surface of said light reflecting member electrically connected with said annular switch and the battery or batteries;
a cylindrical cap having a hollow cavity, a stop edge in an inner surface of said hollow cavity, an annular groove, and female threads formed in an upper portion and in a lower portion of an inner surface of said hollow cavity for threadably combining with said cylindrical housing;
an annular anti-leak gasket provided to fit in said annular groove of said cap;
a lens provided in the hollow cavity of said cap; and,
and an annular position ring having male threads on an outer surface and threadably combined with said cap by engagement of said male threads with said female threads of said cap.

2. The waterproof flashlight as claimed in claim 1, wherein said annular position ring has a plurality of engage grooves formed spaced apart in it inner surface.
